(19) United States
(12) Patent Application Publication
(10) Pub. No.: US 2008/0137254 A1
(43) Pub. Date: Jun. 12, 2008

(54) CIRCUIT BREAKER

(75) Inventor: Allen W. ROO, Dardenne Prairie, MO (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/950,734

(22) Filed: Dec. 5, 2007

Related U.S. Application Data
(60) Provisional application No. 60/868,815, filed on Dec. 6, 2006.

(51) Int. Cl. H02H 9/02

(52) U.S. Cl. 361/93.9

(57) ABSTRACT

The present invention provides a unique circuit breaker that can fit inside restricted spaces and even existing hardware that would otherwise be inaccessible with current circuit breakers. In at least one embodiment, the present disclosure provides a circular circuit breaker with an opening through which wires, hardware, and other equipment can be inserted. The circular circuit breaker departs from generally accepted engineering criteria and enables the use of circuit breakers in far greater numbers of existing electrical devices, such as fans, lamps, and other restricted area electrical devices. The circular circuit breaker can include various electrical devices to enable its function, and the extension of one or more leads therefrom. In at least one embodiment, the circuit breaker can be automatically resettable. When the rated wattage is exceeded, the circuit breaker is tripped and after the wattage is reduced, the circuit breaker automatically switches to an on-state.

### CROSS REFERENCE TO RELATED APPLICATIONS

This application claims the benefit of U.S. Provisional Application Ser. No. 60/868,815, filed Dec. 6, 2006, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The disclosure relates to the field of electrical protective devices. More specifically, the disclosure relates to circuit breakers.

2. Description of the Related Art

A circuit breaker is an automatic electrical switch that stops or restricts the flow of electric current in a sudden overloaded or otherwise abnormally stressed electrical circuit. Unlike a fuse, which operates once and then has to be replaced, a circuit breaker can be reset either manually or automatically to resume normal operation. Circuit breakers can have various sizes from small devices which protect an individual household appliance up to large switch gear designed to protect high voltage circuits providing electricity to a city. There are several types of circuit breakers. At least one type is a magnetic circuit breaker that uses a solenoid. The pulling force of a solenoid increases significantly as current increases. In normal operation, circuit breaker contacts are held closed. As the current in the solenoid increases beyond the rating of the circuit breaker, the solenoid releases a latch which then allows the contacts to open by spring action, breaking the circuit. Another type of circuit breaker is a thermal breaker using a bimetallic strip which bends with increased current. With sufficient bending, the circuit is broken. Other circuit breakers are semiconductor devices which when off, prevent current from flowing but can be turned on with a small electric current through a third electrode, the gate of the semiconductor. This semiconductor device can automatically reset and does not require a tripping mechanism described above. Other circuit breakers can operate in a conductive mode below threshold limits and restrict current flow rates above the threshold limits.

FIG. 1 is an exemplary prior art standard circuit breaker. The circuit breaker 2 generally includes a housing with a plurality of leads 4, 6, 8 extending therefrom. The leads generally include a neutral line and a pair of “hot” lines for electricity to be conducted through the circuit breaker 2. Internal circuitry functions to at least restrict the flow of electrical current when the current attempts to exceed threshold limits. Such standard circuitry is well known to those with ordinary skill in the art and is not believed to be necessary to be described in detail herein.

There have been increased concerns over safety and overloaded uses in low wattage appliances and other electrical devices. Despite well-developed residential or commercial technology for various circuits, where entire circuits can be protected with a single circuit breaker, such circuit breakers do not satisfy a need of protecting individual devices which can be compact in size and otherwise not accessible to manual resetting of a circuit breaker. For examples, lamps, fans, and other household devices generally do not have separate circuit breakers due to the size and compact requirements.

As technology increases, and concern by governmental agencies and the consuming public increase on the use of electricity and safety, there is a need for alternative circuit breakers. Typical rectangular circuit breakers do not provide sufficient flexibility to meet the growing needs of individual circuit breakers for individual electrical devices.

Therefore, there exists a need for a radical departure from known circuit breakers.

### BRIEF SUMMARY OF THE INVENTION

The present invention provides a unique circuit breaker that can fit inside restricted spaces and even existing hardware that would otherwise be inaccessible with current circuit breakers. In at least one embodiment, the present disclosure provides a circular circuit breaker with an opening through which external wires, hardware, and other equipment can pass therethrough. The circular circuit breaker departs from generally accepted engineering criteria and enables the use of a circuit breaker in a far greater number of electrical devices, such as fans, lamps, and other limited volume electrical devices and can include retrofitting existing devices. The circular circuit breaker can include various electrical devices to enable its function, and the extension of one or more leads therefrom. In at least one embodiment, the circuit breaker can automatically reduce an outgoing current. When the rated current and resulting wattage is exceeded, the circuit breaker can be tripped or otherwise restrict the current. After the excess current is resolved, the circuit breaker can automatically switch to an on-state so that the current is not restricted.

The disclosure provides an electrical system, comprising: an electrical device requiring some quantity of electricity from an electrical circuit to operate; and a circuit breaker for protecting the electrical device, comprising: a housing; a plurality of electrical components coupled to the housing and adapted to selectively cause a restriction in the electrical circuit providing electricity to the electrical device when the current would exceed a pre-determined threshold current limit; and an opening formed through the housing and adapted to allow one or more items to be inserted through the circuit breaker from one surface of the circuit breaker to another surface distal from the first surface.

The disclosure also provides a circuit breaker for protecting an electrical device, comprising: a housing; a plurality of electrical components coupled to the housing and adapted to selectively cause a restriction in an electrical circuit providing electricity to the electrical device when the current would exceed a pre-determined threshold current limit; and an opening formed through the circuit breaker and adapted to allow one or more electrical wires to be inserted through the circuit breaker for conducting electricity from one side of the circuit breaker to another side distal from the first side.

### BRIEF DESCRIPTION OF THE SEVERAL VIEWS OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. § 112.

FIG. 1 is an exemplary prior art standard circuit breaker.

FIG. 2 is perspective schematic view of an exemplary electrical device having a circuit breaker disposed therein.

FIG. 3 is a schematic cross-sectional view of a portion of the exemplary electrical device of FIG. 2 illustrating the circuit breaker installed therein.

FIG. 4 is a schematic side view of the circuit breaker.

FIG. 5 is a schematic bottom view of the circuit breaker.

FIG. 6 is a schematic cross-sectional view of the circuit breaker.

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related, and other constraints, which vary by implementation and from time to time. While a developer's efforts might be complex and time-consuming, such efforts would be, nevertheless, a routine undertaking for those of ordinary skill in the art having benefit of this disclosure.

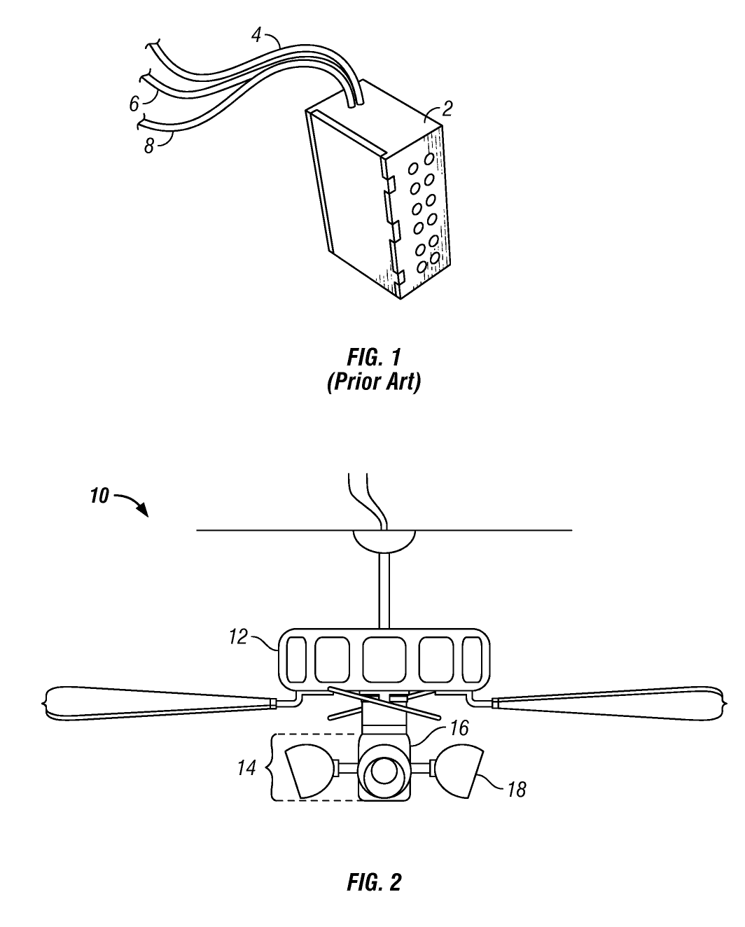

FIG. 2 is perspective schematic view of an exemplary electrical device having a circuit breaker of the present disclosure disposed therein. A system 10 includes an electrical device 12, such as ceiling fan. However, it is to be understood that the circuit breaker of the present disclosure is adapted to fit in many electrical devices, including lights, lamps, appliances, and the like. Thus, it is understood that references to the ceiling fan are merely exemplary and can apply to any electrical device in which it may be practical or useful to have such a circuit breaker coupled thereto. The term “circuit breaker” is used broadly herein and includes circuit breakers that can entirely cause a disconnect in an electrical circuit due to a current overload condition in the circuit that otherwise would exceed a pre-determined threshold current limit, and those devices that are current limiting in terms of limiting an overload on a circuit without causing a disconnect so that the current is able to be conducted through the circuit breaker at or below a pre-determined threshold current limit, but is maintained at or below the threshold limit when the current would otherwise exceed the threshold limit without the circuit breaker. Thus, broadly stated, the circuit breaker selectively causes a restriction in an electrical circuit providing electricity to the electrical device when the current would exceed a pre-determined threshold current limit. The ceiling fan 12 generally includes a light assembly 14 having one or more lamp sockets 18. One or more wires are inserted through the top of the ceiling fan 12 to operate the motor of the ceiling fan and in some cases the lights with the same wire. An excessive amount of wattage caused by an excessive current through the electrical circuit can be detrimental to the wiring, waste energy, or a combination thereof. The present disclosure provides a circular circuit breaker that can be installed into an existing housing of such electrical device without requiring a redesign of the housing and associated hardware. Such flexibility has heretofore been unknown in the field.

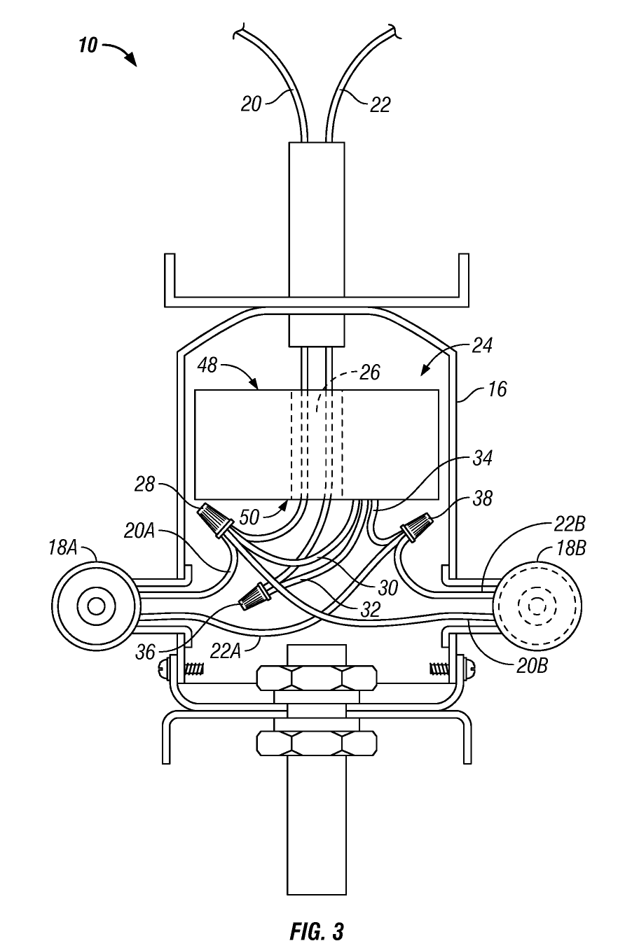

FIG. 3 is a schematic cross-sectional view of a portion of the exemplary electrical device of FIG. 2 illustrating the circuit breaker installed therein. The system 10 can include a housing 16 in which various components of an electrical device are mounted. In the exemplary embodiment, the housing can form the structure to which various lamp sockets 18A, 18B are coupled thereto. Normally, the housing 16 is structured such that prior art circuit breakers will not work in such units. Thus, the industry has been lacking suitable alternatives prior to the present disclosure.

Uniquely, the present disclosure provides a circuit breaker 24 with an opening 26 formed therethrough to allow the wires to pass through the circuit breaker 24 and be coupled to wiring below the circuit breaker. Thus, the opening 26 can function as a wire way. The first wire 20 and the second wire 22 can be disposed in a generally understood manner through the top of the system 10, such as ceiling fan, and routed through the inner portions of the system. The circuit breaker 24 can be sandwiched in the housing 16 and the wires inserted through the opening 26 to below the circuit breaker 24. In the exemplary embodiment, the first wire 20 can be coupled with a connector 28 to a wire 20A leading to a lamp socket 18A and also coupled to a wire 20B leading to a lamp socket 18B. The second wire 22 can be coupled through a connector 36 to a lead 32 coupled to the circuit breaker 24. The circuit breaker can further include a lead 30 that is coupled to the wires 20, 20A, 20B with a connector 28. Similarly, a lead 34 can be connected through a connector 38 to wires 22A, 22B coupled to the lamp sockets 18A, 18B, respectively, to complete to the circuit. The number of wires and connections depends upon the number of electrical outlets and other electrical loads of the particular device in question. The exemplary embodiment having two lamp sockets is merely illustrative of the concept disclosed herein. Thus, an electrical current is routed through the circuit breaker 24, so that when excess current (with resulting wattage) is detected, the circuit breaker can trip or otherwise restrict the electrical circuit. Generally, no excess amount of electricity, if any, flows through the electrical circuit until the overload condition is corrected.

In at least one embodiment, the circuit breaker 24 can be shaped as a disc, although other shapes are possible. More specifically, the circuit breaker can appear as a toroid having the central opening 26 formed therethrough. The opening 26, as a wire way, can start at a first surface 48, such as a top, and extend through the circuit breaker to a second surface 50, such as a bottom, distal from the first surface. The opening 26 can be circular, square, rectangular, or other shapes may be appropriate for the particular installation.

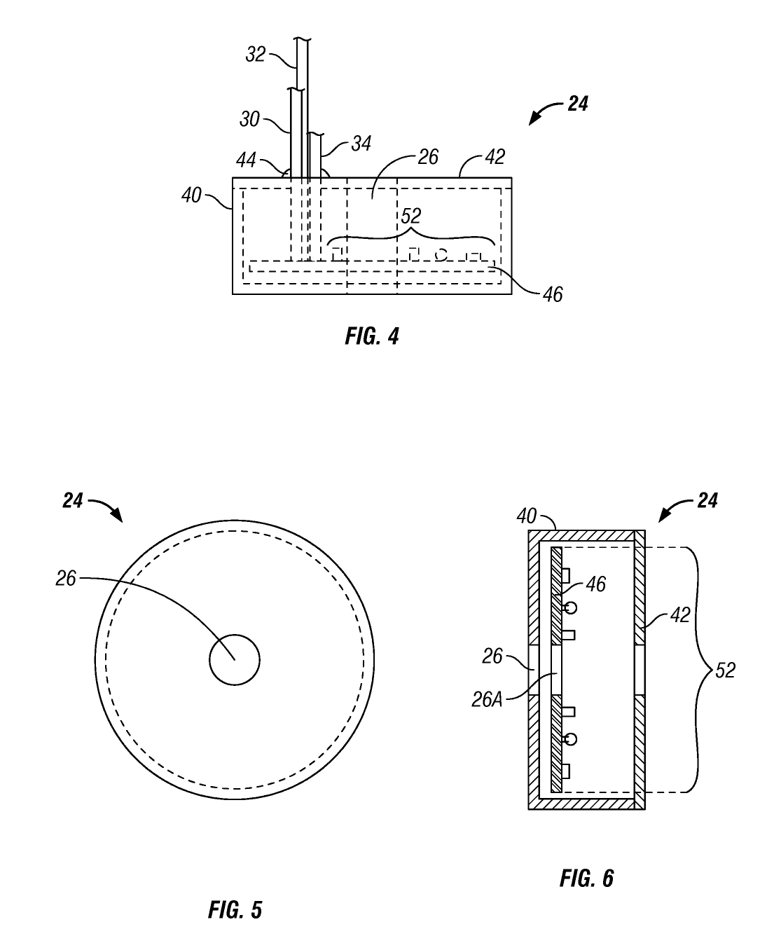

FIG. 4 is a schematic side view of the circuit breaker. In at least one embodiment, the circuit breaker 24 can include a housing 40 from various known materials that are heat resistant and structurally sufficient to support the use of a circuit breaker. The housing 40 can be partially hollow and covered by a cover 42 to seal components therein. The cover 42 can also include a seal 44 surrounding one or more leads extending through the cover. For example, a circuit board 46 can be disposed in the housing 40 from which the leads 30, 32, 34 can extend. The circuit board generally includes a plurality of electrical components 52 coupled together to provide the circuitry useful to sense and operate the circuit breaker in an over-current condition. The opening 26 is also shown passing through the circuit breaker 24. Merely as exemplary and without any limitation as to size, one size of the circuit breaker could include about one inch or less in height and about two inches or less in diameter. Such dimensions could be appropriate for various lamps, fans, and other electrical devices without necessarily requiring retooling and redesign of the various housings of the devices.

FIG. 5 is a schematic bottom view of the circuit breaker. The circuit breaker 24 generally includes the opening 26 disposed therethrough. The opening provides an additional path through which electrical wires and other electrical conduit media including without limitation wires, optical fiber, devices, hardware, and other elements can pass through the circuit breaker 24 under such minimal space availability. In at least one embodiment, the opening 26 can be centrally disposed in the circuit breaker 24.

FIG. 6 is a schematic cross-sectional view of the circuit breaker. The circuit breaker 24 generally includes the housing 40 coupled to cover 42 as described above. The housing 40 can be at least partially hollow such that various elements such as the circuit board 46 can be disposed therein. As merely a schematic, the circuit board does not show in this view the leads 30, 32, 34 extending therefrom as is shown in various other figures herein. Further, the circuit board 46 can include an opening 26A which is generally aligned with the opening 26 formed through the housing 40 and the cover 42.

The various steps described or claimed herein can be combined with other steps, can occur in a variety of sequences unless otherwise specifically limited, various steps can be interlineated with the stated steps, and the stated steps can be split into multiple steps. Unless the context requires otherwise, the word “comprise” or variations such as “comprises” or “comprising,” should be understood to imply the inclusion of at least the stated element or step or group of elements or steps or equivalents thereof, and not the exclusion of any other element or step or group of elements or steps or equivalents thereof. Also, any directions such as “top,” “bottom,” “left,” “right,” “upper,” “lower,” and other directions and orientations are described herein for clarity in reference to the figures and are not to be limiting of the actual device or system or use of the device or system. The device or system may be used in a number of directions and orientations. The term “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include without limitation integrally forming one functional member with another in a unity fashion. The coupling can occur in any direction, including rotationally.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant(s), but rather, in conformity with the patent laws, Applicant(s) intend to protect all such modifications and improvements to the full extent that such falls within the scope or range of equivalent of the following claims.

Further, any documents to which reference is made in the application for this patent as well as all references listed in any list of references filed with the application are hereby incorporated by reference. However, to the extent statements might be considered inconsistent with the patenting of this invention, such statements are expressly not to be considered as made by the Applicant(s).

1. An electrical system, comprising:
an electrical device requiring some quantity of electricity from an electrical circuit to operate; and
a circuit breaker for protecting the electrical device, comprising:
a housing;
a plurality of electrical components coupled to the housing and adapted to selectively cause a restriction in the electrical circuit providing electricity to the electrical device when the current would exceed a pre-determined threshold current limit; and
an opening formed through the housing and adapted to allow one or more items to be inserted through the circuit breaker from one surface of the circuit breaker to another surface distal from the first surface.

2. The system of claim 1, wherein the electrical device comprises a light.

3. The system of claim 1, wherein the electrical device comprises an electrical fan.

4. The system of claim 1, wherein the circuit breaker is round.

5. The system of claim 1, wherein the first surface of the opening comprises a top surface of the circuit breaker and the second surface comprises a bottom surface of the circuit breaker.

6. The system of claim 1, wherein the circuit breaker is adapted to fit inside a housing of an electrical fan.

7. The system of claim 1, wherein the plurality of electrical components is coupled to a circuit board, the circuit board having an opening therethrough aligned with the opening through the housing.

8. The system of claim 1, wherein the circuit breaker comprises a toroid.

9. The system of claim 1, wherein the housing comprises a hollow cavity and the circuit breaker further comprises a cover extending over the housing with one or more leads extending therefrom for coupling with wires in the electrical circuit.

10. A circuit breaker for protecting an electrical device, comprising:
a housing;
a plurality of electrical components coupled to the housing and adapted to selectively cause a restriction in an electrical circuit providing electricity to the electrical device when the current would exceed a pre-determined threshold current limit; and
an opening formed through the circuit breaker and adapted to allow one or more electrical wires to be inserted through the circuit breaker for conducting electricity from one side of the circuit breaker to another side distal from the first side.

11. The circuit breaker of claim 10, wherein the circuit breaker defines a round periphery.

12. The circuit breaker of claim 10, wherein the circuit breaker is shaped as a disc.

13. The circuit breaker of claim 12, wherein the disc comprises a toroid.

14. The circuit breaker of claim 10, wherein the housing comprises a hollow cavity and the circuit breaker further comprises a cover extending over the housing with one or more leads extending therefrom for coupling with wires in the electrical circuit.

15. A ceiling fan having the circuit breaker of claim 10 coupled thereto.

16. A light having the circuit breaker of claim 10 coupled thereto.
